(19) United States
(12) Patent Application Publication
(10) Pub. No.: US 2026/0169736 A1
(43) Pub. Date: Jun. 18, 2026

(54) VECTOR-INTEGER STORE DATA AVOIDANCE SCHEME

(71) Applicant: Intel Corporation, Santa Clara, CA (US)

(72) Inventors: Jonathan HALL, Portland, OR (US); Brian HICKMANN, Sherwood, OR (US); Paula PETRICA, Portland, OR (US)

(73) Assignee: Intel Corporation, Santa Clara, CA (US)

(21) Appl. No.: 18/981,387

(22) Filed: Dec. 13, 2024

(51) Int. Cl. G06F 9/30

(52) U.S. Cl. CPC G06F 9/30036; G06F 9/30149

(57) ABSTRACT

Techniques for a processor, method and system to implement a vector-integer store data avoidance scheme. An integer logic circuit dispatches an integer store data operation to route integer data to a destination on a first set of connection lines. A vector logic circuit schedules a vector store data operation to transfer vector data to the destination, block dispatch of an integer store data operation to the destination, route higher bits of the vector data via a second set of connection lines to a destination, and route lower bits of the vector data to the integer logic circuit and use the first set of connection lines used for routing of integer data to the destination to route the lower bits of the vector data to the destination.

### BACKGROUND

Integer instructions are type of computer instructions that perform operations on integer values. Vector instructions are a type of computer instruction that perform the same operation on multiple data. Store Data (STD) instructions perform operations to store data to a destination location. Integer STD operations store integer data, while vector STD operations store vector data.

In order to perform both integer STD and vector STD operations, previous practice is to dispatch all store data micro-operations (uops) from the same set of schedulers (arbitrating based on the type of uop scheduled) or by using replicated wires (one set for the integer STD operation and one set for the vector STD operation). The former is not practical when the vector and integer register files are far apart (e.g., separate integer and vector clusters). The latter increases the number of wires that need to be routed.

### BRIEF DESCRIPTION OF DRAWINGS

Various examples in accordance with the present disclosure will be described with reference to the drawings, in which:

FIG. 1 illustrates an example of an integer unit and a vector unit that share lines to store data at a destination according to some examples of the disclosure.

FIG. 2 illustrates an example of clustering integer units into an integer cluster and vector units into a vector cluster to perform the technique of FIG. 1 according to some examples of the disclosure.

FIG. 3 illustrates an example of how to suppress a dispatch of an integer STD when a vector STD dispatch is scheduled according to some examples of the disclosure.

FIG. 4 illustrates a flow diagram for a method implemented by an integer unit and a vector unit that share lines to store data to a destination according to some examples of the disclosure.

FIG. 5 illustrates examples of computing hardware to process a STD or VSTD instruction.

FIG. 6 illustrates an example method performed by a processor to process a STD or VSTD instruction.

FIG. 7 illustrates an example computing system.

FIG. 8 illustrates a block diagram of an example processor and/or System on a Chip (SoC) that may have one or more cores and an integrated memory controller.

FIG. 9(A) is a block diagram illustrating both an example in-order pipeline and an example register renaming, out-of-order issue/execution pipeline according to examples.

FIG. 9(B) is a block diagram illustrating both an example in-order architecture core and an example register renaming, out-of-order issue/execution architecture core to be included in a processor according to examples.

FIG. 10 illustrates examples of execution unit(s) circuitry, such as execution unit(s) circuitry.

FIG. 11 is a block diagram of a register architecture according to some examples.

FIG. 12 illustrates examples of an instruction format.

FIG. 13 illustrates examples of an addressing information field.

### DETAILED DESCRIPTION

The present disclosure relates to methods, apparatus and systems for a Vector-Integer (VEC-INT, or V-I) store data (STD) avoidance scheme. According to some examples, the technique described in the disclosure can save wires that need to be routed while keeping vector STD micro-operations (uops) proximal to vector physical register files (PRFs). In order to overcome some of the shortcomings described with the previous practice (as noted in the Background above), integer STD (STD) and vector STD (VSTD) uops share some of the same wires into a memory, such as cache memory, but are independently scheduled from areas that are far apart. An arbitration between vector and integer STD uops can prevent starvation and can enable reduced wiring. That is, the disclosed scheme routes fewer wires, thereby reducing circuit area and power consumption on a semiconductor chip.

Furthermore, although the description uses the STD operation, the scheme can be used with other instructions and operations, and not be limited specifically to STD and STD uops. The disclosure refers to integer STD uops to be 64-bits wide and vector STD uops to be 128-bits wide; however, it need not be limited to these bit width. Other schemes can employ different bit widths.

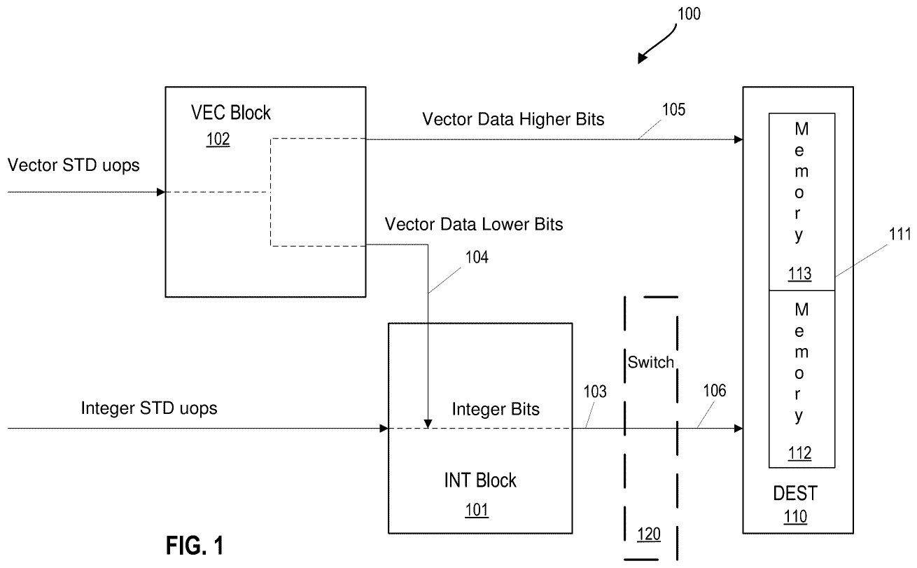

FIG. 1 illustrates an example of an integer unit and a vector unit that share lines to store data at a destination according to some examples of the disclosure. FIG. 1 shows a portion of a processor 100 that includes an integer (INT) unit or INT block 101 (also referred to as INT logic or INT logic circuit) for handling integer STD uop(s) and a vector (VEC) unit or VEC block 102 (also referred to as VEC logic or VEC logic circuit) for handling vector STD uop(s). In some examples, INT block 101 and VEC block 102 are part of an execution unit (e.g., execution logic) of the processor 100. The target of the data load for the STD uops is destination 110, which typically is or includes a memory 111. The memory 111 can be any type of memory, including cache memory, main memory, graphics memory, etc. In some examples, memory 111 is a cache memory or cache memories. In some examples, a switching unit or switching logic, noted as switch 120, may be included.

For the example processor 100 of FIG. 1, integer STD uops are 64-bits wide and vector STD uops are 128-bits wide. The INT block 101 receives the integer STD uops and operates on the integer STD uops. The INT block 101 schedules and outputs a 64-bit data on a set of connection lines (e.g., first set of connection lines), shown as line 103, for storage in a 64-bit portion 112 of memory 111 at destination 110. Thus, the integer block 101 operates on “n” number of bits, where n=64 in the described example.

The VEC block 102 receives 128-bit (2n-bit) vector STD uops and operates on the vector STD uops. Instead of outputting a 128-bit data on a set of lines together for transfer to the destination 110 (e.g., memory 111), the transfer from the VEC block 102 relies on scheduling and routing the higher n-bits (e.g., 64-bits) of data separately from the lower n-bits (e.g., 64-bits) of data. The VEC block 102 separates the routing of the 128-bit data, wherein the lower bits (e.g., lower 64-bits) are scheduled and routed, via a set of connection lines, shown as line 104, to the INT block 101 to use the same set of connection lines 103 used for the routing of the 64-bit integer data. The higher bits (e.g., higher 64-bits) are scheduled and separately routed on a set of connection lines (e.g., second set of connection lines), shown as line 105, to the destination 110 (e.g., memory 111) so that the lower 64-bit portion of the 128-bit data is stored in a 64-bit portion 112, while the upper 64-bit portion of the 128-bit data is stored in a different portion 113 of memory 111. The two portions 112 and 113 of memory 111 combine to form the 128-bit data. The combined 128-bit vector data can then be released from the memory 111.

The switch 120, when present can operate to transfer the first set of connection lines 103 to a third set of connection lines, shown as line 106. Hence, when there are other set(s) of connection lines as inputs to switch 120, the switch 120 can switch between/among them for output on the set of connection lines 106 for output to memory 111.

Although the disclosure describes a 64-bit length for the integer data and 128-bit length for the vector data, in which the lower 64 number of bits are routed on the integer lines, some examples may use different bit lengths. Furthermore, the vector data length need not be limited to twice the integer data length. Hence, in some examples, the integer data has a length of n-bits and the vector data has a length of m-bits, where m>n, and in which the vector data comprises n number of lower bits and m−n number of higher bits. The n number of lower bits are routed on the integer lines and the m−n number of higher bits are routed separately.

Thus, the disclosure describes a processor that includes an integer logic circuit to dispatch an integer store data operation to route integer data to a destination on a first set of connection lines; and a vector logic circuit to schedule a vector store data operation to transfer vector data to the destination, block dispatch of an integer store data operation to the destination, route higher bits of the vector data via a second set of connection lines to a destination, and route lower bits of the vector data to the integer logic circuit and use the first set of connection lines used for routing of integer data to the destination to route the lower bits of the vector data to the destination.

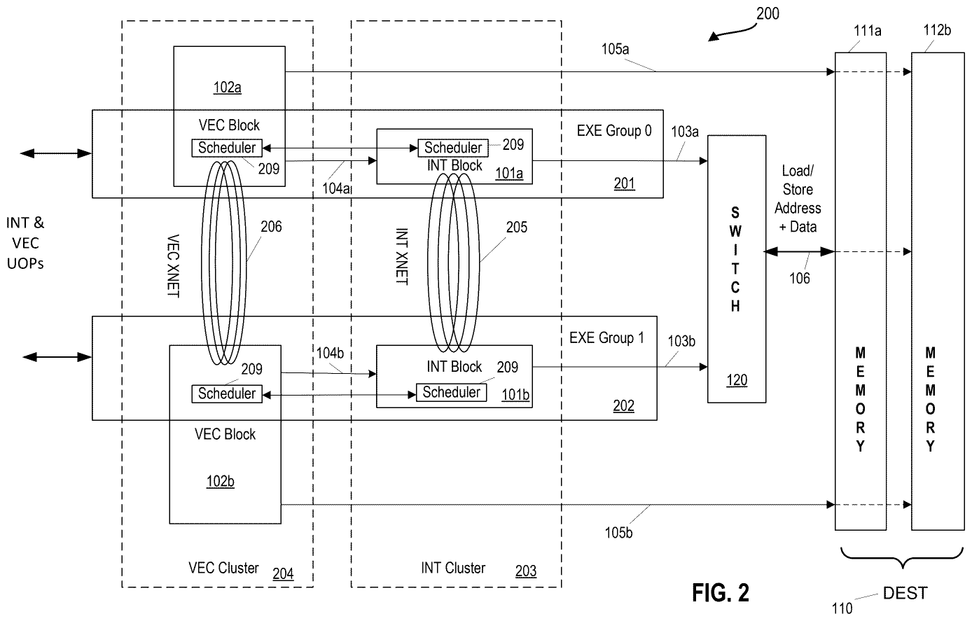

FIG. 2 illustrates an example of clustering integer units into an integer cluster and vector units into a vector cluster to perform the technique of FIG. 1 according to some examples of the disclosure. FIG. 2 implements the technique described in reference to FIG. 1, in which a clustered micro-architecture clusters a number of INT blocks 101 into an integer cluster (INT cluster) 203 and clusters a number of VEC blocks 102 into a vector cluster (VEC cluster) 204. For a processor 200 of FIG. 2, multiple execution groups of integer block-vector block combinations can be configured. FIG. 2 only shows two execution unit groups 201 and 202 (labeled EXE Group 0, EXE Group 1). However, some examples may employ other number or combination of EXE groups and is not limited to two. In FIG. 2, like numbers are used as shown in FIG. 1 but with the suffix “a” or “b” depending on the execution grouping. Thus, EXE Group 201 includes INT block 101a, VEC block 102a, and sets of connection lines 103a, 104a, 105a; and EXE Group 202 includes INT block 101b, VEC block 102b, and sets of connection lines 103b, 104b, 105b.

The various INT blocks 101 are clustered together as part of the INT cluster 203 and various VEC blocks 102 are clustered together as part of the VEC cluster 204. The units in a cluster can communicate and transfer data with other units in the same cluster (intra-cluster) using a network, such as a ring-type network, shown as XNET in FIG. 2. An INT XNET 205 connects the INT blocks 101 of INT cluster 203 and an VEC XNET 206 connects the VEC blocks 102 of VEC cluster 204. The INT XNET 205 and the VEC XNET 206 can have multiple rings to provide multiple data paths to permit communication between units in the corresponding cluster. Although processor 200 shows ring-type networks, other types of communication networks can be used.

Furthermore, in some examples the number of INT blocks 101 in the INT cluster 203 need not be the same as the number of VEC blocks 102 in the VEC cluster 203. For example, a processor may have four INT blocks 101 in the INT cluster 203 and only two VEC blocks 102 in the VEC cluster 204, in which case two EXE groups would have both the INT blocks 101 and VEC block 102, while two other EXE groups would have just the INT block 101.

A scheduler 209 in each corresponding INT block 101 and VEC block 102 provides scheduling control for transferring information to and from these units. In some examples, a set of integer sink (SINK) schedulers and vector sink (VSINK) schedulers are used for schedulers 209 to support the clustered micro-architecture. The SINK scheduler in the INT block 101 would dispatch integer intra-cluster moves within the INT cluster 203 and dispatch integer STD uops. The VSINK schedulers in the VEC block 102 would dispatch vector intra-cluster moves within the VEC cluster 204 and dispatch vector STD uops. Because the wiring for the lower 64-bits of VSTD is shared with the 64-bits of the INT block 101, the vector STD uop dispatch from a VSINK scheduler requires a vector cross-cluster move of the lower 64-bits to the INT block 101 of the corresponding EXE group, as exemplified by line 104. The cross-cluster move can be achieved via a cross-cluster connection between the INT XNET and the VEC XNET or via a separate cross-cluster connection.

The INT blocks 101 can output data to the destination 110, via switch 120, when executing an integer STD uop. The switch 120 selects between the various set of connection lines 103 (e.g., 103a, 103b) for output on the set of connection lines 106. In some examples, switch 120 is a crossbar (XBAR) switch. The VEC blocks 102 send the lower bits of the vector data from the vector STD operation to the corresponding INT block 101 for output onto the lines used for the integer data of the integer STD. The higher bits of the vector data from the vector STD are sent onto the lines 105 to the destination 110 without traversing the switch 120. Although two distinct lines 105a and 105b are shown in FIG. 2, the schedulers 209 of the VEC blocks 102 can place the higher bit output on a common set of lines to the destination 110.

The wiring plan of FIG. 2 sends the higher bits (e.g., higher 64-bits) of the vector data of the vector STD directly to the memory 111, and sends the lower bits (e.g., lower 64-bits) of the vector data to the wires used by the integer data of the integer STD operation to send the lower vector bits to the memory. The memory 111 can be of a variety of memory for storing data. In some examples memory 111 can be cache memory, such as a Level 1 (L1) cache memory. In some examples, there may be two different memories 111a and 111b. In some examples, memory 111a can be L1 cache memory and memory 111b can be a Level 2 (L2) memory. In an example operation, integer STD operations can store integer data into the L1 cache memory 111a, while vector STD operations can store the vector data into the L2 cache memory 111b.

To share the wires, a vector STD cancels any integer STD that might try to use the same wires at the same time that the vector STD is sending the vector data. The vector-integer interface, used by the vector STD data, as well as a vector to integer move onto the integer lines, identifies which INT block 101 needs to have suppressed one of its integer STD dispatches.

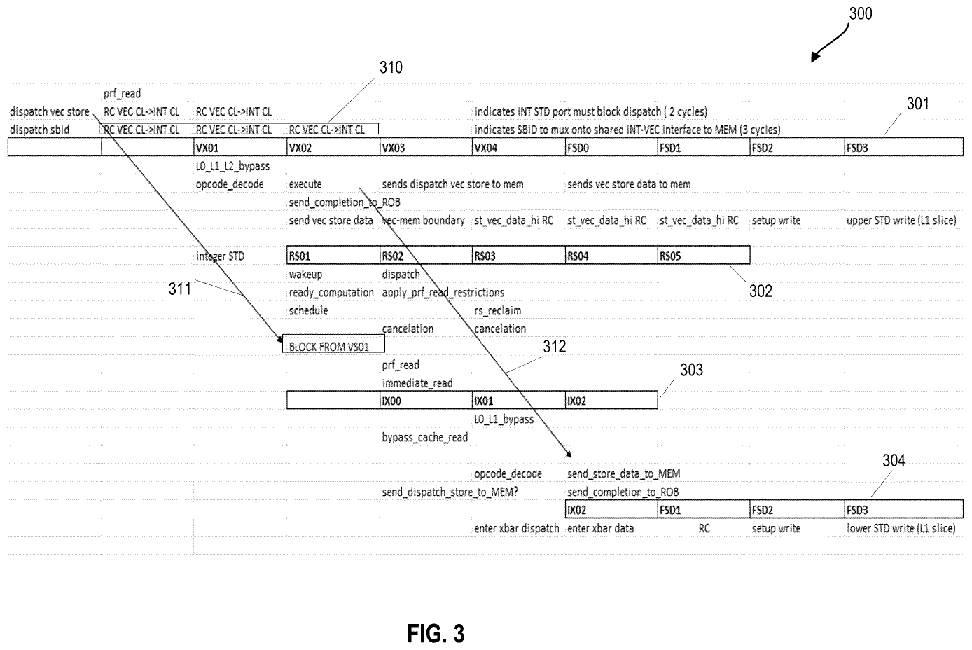

FIG. 3 show an example of how to suppress a dispatch of an integer STD when a vector STD dispatch is scheduled according to some examples of the disclosure. FIG. 3 shows a timing diagram 300 in which the first row 301 indicates vector STD dispatches to the destination 110, second row 302 indicates upper (higher-bit) vector STD data transfer to the destination 110, third row 303 indicates integer STD data transfer to the destination 110 and the fourth row 304 indicates lower (lower-bit) vector STD transfer to the destination 110. The destination can be a memory, such as a L1 cache memory. The lower vector STD data transfer is via the XBAR switching as described in FIG. 2. A vector STD dispatch 310 is shown to occur over three time periods. In order not to have an interrupting integer STD dispatch while the lower portion of the vector data is utilizing the integer lines (see arrow 312), an integer STD block signal (see arrow 311) is sent from the dispatching schedular 209 to the schedular of the corresponding INT block 101 to prevent the INT block 101 from dispatching an integer STD data. Thus, a vector STD dispatch blocks an integer STD dispatch.

However, a vector to integer move between the clusters 203 and 204 (e.g., cross-cluster transfer) does not require an integer block. There is no distributed conflict between a vector to integer move between the clusters and a vector STD operation, since they would schedule from the same (e.g., VSINK) scheduler, so that the scheduler 209 would arbitrate the conflict. The scheduler (e.g., SINK) 209 for the INT block 101 simultaneously finds the oldest ready integer STD and cross-cluster move. If a vector STD is on its way for that scheduler, then the cross-cluster move is selected, since the cross-cluster move does not impact the vector STD using the integer set of connection lines 103 for routing the vector STD data.

Furthermore, for the transfer of vector data from the vector STD operation, pipeline complexity is involved to ensure that the lower and higher store data portions arrive in the next level of cache together. Since a large stream of re-dispatching VSTD uops could block forward progress, the pipeline operation attempts to avoid always blocking conflicting integer STD dispatches. A number of options are available to ensure that integer STD dispatch is not interrupted excessively by occurrence of numerous vector STD dispatches.

One technique to control undue blocking of integer STD dispatch is to limit the number of the vector STD dispatch to the destination to no more than N times in an M time period or M time cycle, N and M being numbers. Another technique is to determine if any integer STD dispatch was previously blocked and: if no, dispatch the vector STD operation; and if yes, allow the integer STD previously blocked to be routed before dispatching the vector STD data operation. Other schemes can be implemented as well.

Accordingly, a system is described having a memory; a switch coupled to the memory; a cluster of integer units, each integer unit having an integer logic circuit to dispatch an integer store data operation to route integer data to the switch on a first set of connection lines, wherein the switch switches corresponding one of the first set of connection lines onto a third set of connection lines to the memory; and a cluster of vector units, each vector unit having a vector logic circuit to schedule a vector store data operation to transfer vector data to the memory, block dispatch of an integer store data operation to the memory, route higher bits of the vector data via a second set of connection lines to the memory, and route lower bits of the vector data to a corresponding integer logic circuit and use the first set of connection lines used for routing of integer data to the switch, wherein the switch to route the lower bits of the vector data to the memory on the third set of connection lines.

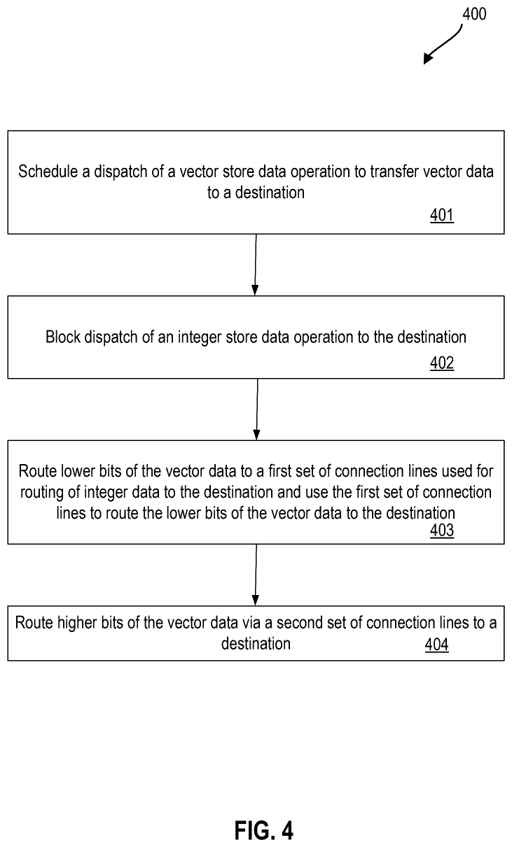

FIG. 4 illustrates a flow diagram of a method implemented by an integer unit and a vector unit that share lines to store data to a destination according to some examples of the disclosure. The flow diagram shows a method (or process) 400 which can be practiced by a processor that operates on integer and vector instructions and/or uops to store data to a destination location, such as memory. As shown in operation 401, the operation schedules a dispatch of a vector STD operation to transfer data to the destination. The vector operation splits the routing of the data by transferring the higher bit portion of the vector STD data to memory but using existing integer lines to route the lower bit portion of the vector STD data.

In order to prevent conflicting use of the integer lines, operation 402 blocks a dispatch of integer STD operation to send integer data to the destination, when a vector STD operation is dispatched. Once the conflict is resolved by preventing the dispatch of integer the STD, in operation 403, the lower bits of the vector STD are routed to the integer lines used for routing integer data of the vector STD to the destination.

In operation 404, the higher bits of the vector data are routed to the destination via a separate routing path from the lower bits of the vector data. At the destination, the lower and higher bit portions are combined and can be released. The method 400 can be practiced by utilizing the processors 100 and 200 described above according to some examples.

Thus, the disclosed scheme routes fewer wires, thereby reducing circuit area and power consumption on a semiconductor chip.

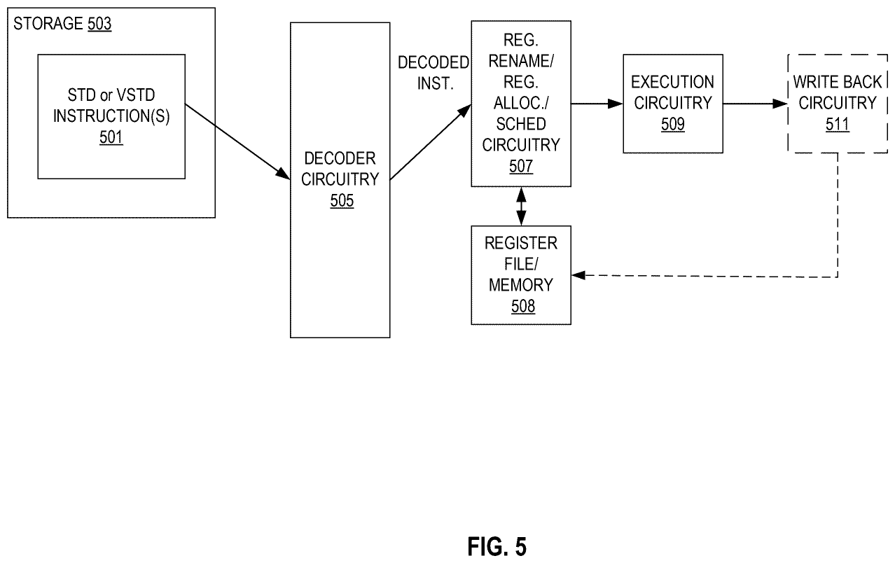

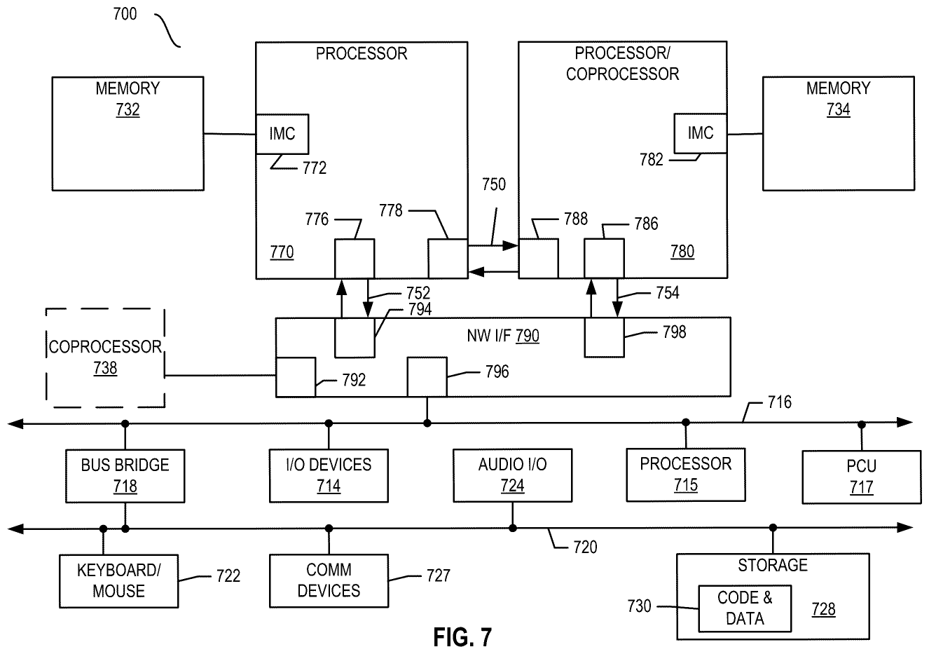

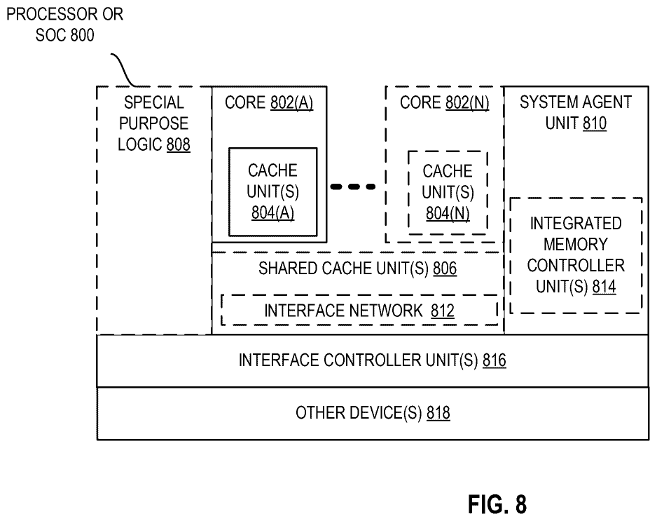

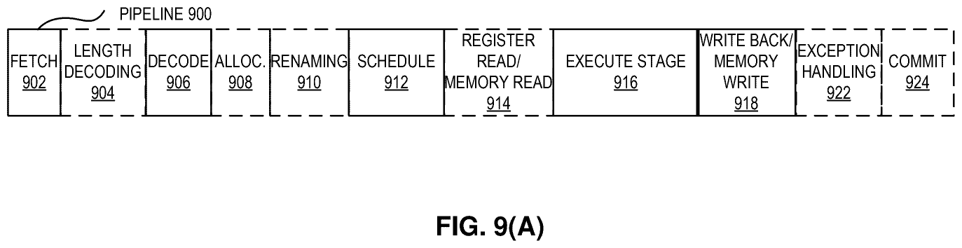

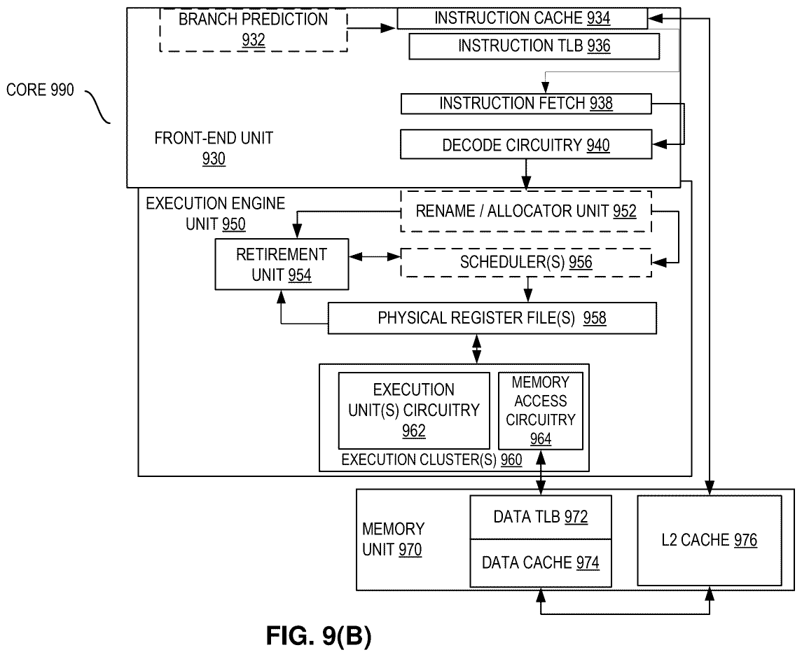

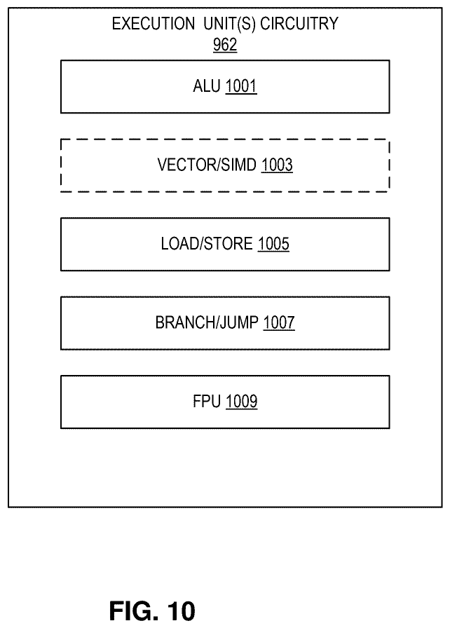

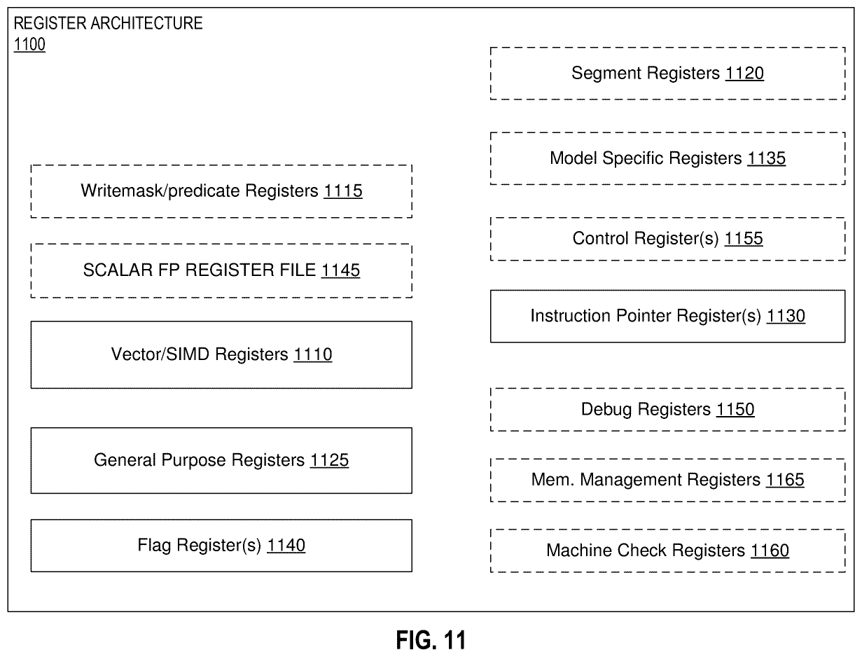

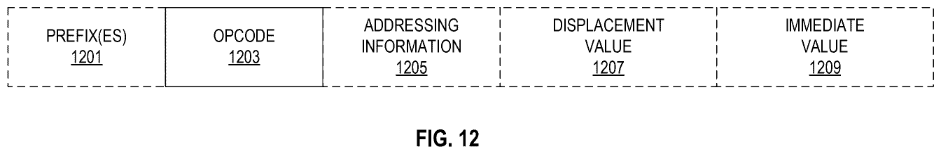

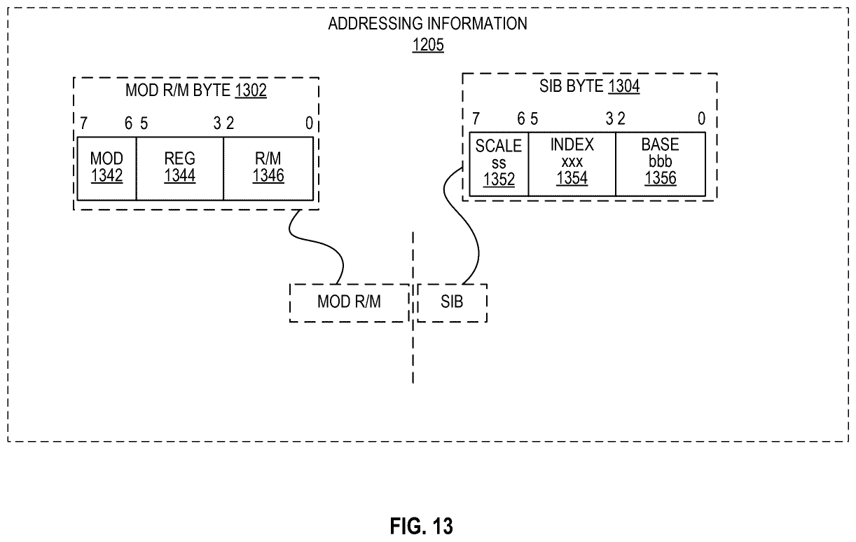

Although the disclosure describes some examples above, other techniques can implement the same or equivalent techniques described. The processor 100, 200 can be implemented in a processor or coprocessor shown in FIG. 5, FIG. 7 and FIG. 8 performing operations to execute a store data instruction. FIG. 9A shows a pipeline that can be duplicated in a processor, including the processor 100, 200. FIG. 9B shows an example system having execution units and memory units to route integer STD data and vector STD data to perform the above described operations. FIG. 10 shows another example of an execution unit to perform the functions of the INT block and VEC blocks of FIG. 1 and FIG. 2. FIG. 11 shows a register architecture showing various registers that can be used with the processor 100, 200. FIG. 12 and FIG. 13 show an instruction format and addressing information which can be used for the STD or VSTD instructions.

FIG. 5 illustrates examples of computing hardware to process a Store Data (STD) instruction. The instruction may be an integer STD instruction or a Vector STD instruction (Herein noted as STD/VSTD). As illustrated, storage 503 stores a STD or VSTD instruction 501 to be executed.

The instruction 501 is received by decoder circuitry 505. For example, the decoder circuitry 505 receives this instruction from fetch circuitry (not shown). The instruction may be in any suitable format, such as that describe with reference to FIG. 12 below. In an example, the instruction includes fields for an opcode, and a destination identifier. In some examples, the sources and destination are registers, and in other examples one or more are memory locations. In some examples, one or more of the sources may be an immediate operand.

More detailed examples of at least one instruction format for the instruction will be detailed later. The decoder circuitry 505 decodes the instruction into one or more operations. In some examples, this decoding includes generating a plurality of micro-operations to be performed by execution circuitry (such as execution circuitry 509). The decoder circuitry 505 also decodes instruction prefixes.

In some examples, register renaming, register allocation, and/or scheduling circuitry 507 provides functionality for one or more of: 1) renaming logical operand values to physical operand values (e.g., a register alias table in some examples), 2) allocating status bits and flags to the decoded instruction, and 3) scheduling the decoded instruction for execution by execution circuitry out of an instruction pool (e.g., using a reservation station in some examples).

Registers (register file) and/or memory 508 store data as operands of the instruction to be operated by execution circuitry 509. Example register types include packed data registers, general purpose registers (GPRs), and floating-point registers.

Execution circuitry 509 executes the decoded instruction. The execution of the decoded instruction causes the execution circuitry to perform the STD or VSTD operation.

In some examples, retirement/write back circuitry 511 architecturally commits the destination register into the registers or memory 508 and retires the instruction. An example of a format for an STD/VSTD instruction is OPCODE DST, SRC1, SRC2. In some examples, OPCODE is the opcode mnemonic of the instruction. DST is a field for a location of destination operand, such as a general-purpose register, a packed data register, or memory. SRC1 and SRC2 are fields locations of source operands, such as general-purpose registers, packed data registers, and/or memory. In some examples, the opcode is provided by field 1203.

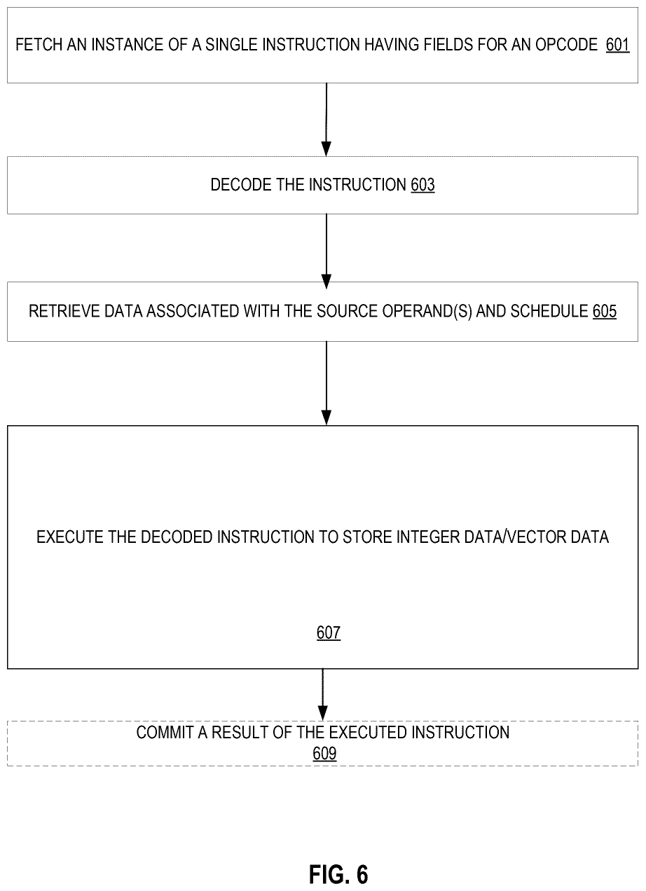

FIG. 6 illustrates an example method performed by a processor to process a Store Integer Data or Store Vector Data instruction. For example, a processor core as shown in FIG. 9(B), a pipeline as detailed below, etc., performs this method.

At 601, an instance of single instruction is fetched. For example, an STD or VSTD instruction is fetched. The instruction includes fields for an opcode,. In some examples, the instruction further includes a field for a writemask. In some examples, the instruction is fetched from an instruction cache. The opcode indicates store data operation (INT STD or VEC STD) to be performed.

The fetched instruction is decoded at 603. For example, the fetched instruction is decoded by decoder circuitry such as decoder circuitry 505 or decode circuitry 940 detailed herein.

Data values associated with the source operands of the decoded instruction are retrieved when the decoded instruction is scheduled at 605. For example, when one or more of the source operands are memory operands, the data from the indicated memory location is retrieved.

At 607, the decoded instruction is executed by execution circuitry (hardware) such as execution circuitry 509 shown in FIG. 5, or execution cluster(s) 960 shown in FIG. 9(B).

In some examples, the instruction is committed or retired at 609.

### Example Architectures

Detailed below are descriptions of example computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

### Example Systems

FIG. 7 illustrates an example computing system. Multiprocessor system 700 is an interfaced system and includes a plurality of processors or cores including a first processor 770 and a second processor 780 coupled via an interface 750 such as a point-to-point (P-P) interconnect, a fabric, and/or bus. In some examples, the first processor 770 and the second processor 780 are homogeneous. In some examples, first processor 770 and the second processor 780 are heterogenous. Though the example multiprocessor system 700 is shown to have two processors, the system may have three or more processors, or may be a single processor system. In some examples, the computing system is a system on a chip (SoC).

Processors 770 and 780 are shown including integrated memory controller (IMC) circuitry 772 and 782, respectively. Processor 770 also includes interface circuits 776 and 778; similarly, second processor 780 includes interface circuits 786 and 788. Processors 770, 780 may exchange information via the interface 750 using interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a network interface (NW I/F) 790 via individual interfaces 752, 754 using interface circuits 776, 794, 786, 798. The network interface 790 (e.g., one or more of an interconnect, bus, and/or fabric, and in some examples is a chipset) may optionally exchange information with a co-processor 738 via an interface circuit 792. In some examples, the co-processor 738 is a special-purpose processor, such as, for example, a high-throughput processor, a network or communication processor, a compression engine, a graphics processor, a general purpose graphics processing unit (GPGPU), a neural-network processing unit (NPU), an embedded processor, a security processor, a cryptographic accelerator, a matrix accelerator, an in-memory analytics accelerator,, a data streaming accelerator, data graph operations, or the like.

A shared cache (not shown) may be included in either processor 770, 780 or outside of both processors, yet connected with the processors via an interface such as P-P interconnect, such that either or both processors' local cache information may be stored in the shared cache if a processor is placed into a low power mode.

Network interface 790 may be coupled to a first interface 716 via interface circuit 796. In some examples, first interface 716 may be an interface such as a Peripheral Component Interconnect (PCI) interconnect, a PCI Express interconnect or another I/O interconnect. In some examples, first interface 716 is coupled to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interface 716, along with a bus bridge 718 which couples first interface 716 to a second interface 720. In some examples, one or more additional processor(s) 715, such as co-processors, high throughput many integrated core (MIC) processors, GPGPUs, accelerators (such as graphics accelerators or digital signal processing (DSP) units), field programmable gate arrays (FPGAs), or any other processor, are coupled to first interface 716. In some examples, second interface 720 may be a low pin count (LPC) interface. Various devices may be coupled to second interface 720 including, for example, a keyboard and/or mouse 722, communication devices 727 and storage circuitry 728. Storage circuitry 728 may be one or more non-transitory machine-readable storage media as described below, such as a disk drive or other mass storage device which may include instructions/code and data 730 and may implement the storage 503 in some examples. Further, an audio I/O 724 may be coupled to second interface 720. Note that other architectures than the point-to-point architecture described above are possible. For example, instead of the point-to-point architecture, a system such as multiprocessor system 700 may implement a multi-drop interface or other such architecture.

### Example Core Architectures, Processors, and Computer Architectures

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a co-processor including one or more special purpose cores intended primarily for graphics and/or scientific (throughput) computing. Such different processors lead to different computer system architectures, which may include: 1) the co-processor on a separate chip from the CPU; 2) the co-processor on a separate die in the same package as a CPU; 3) the co-processor on the same die as a CPU (in which case, such a co-processor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described co-processor, and additional functionality. Example core architectures are described next, followed by descriptions of example processors and computer architectures.

FIG. 8 illustrates a block diagram of an example processor and/or SoC 800 that may have one or more cores and an integrated memory controller. The solid lined boxes illustrate a processor and/or SoC 800 with a single core 802(A), system agent unit circuitry 810, and a set of one or more interface controller unit(s) circuitry 816, while the optional addition of the dashed lined boxes illustrates an alternative processor and/or SoC 800 with multiple cores 802(A)-(N), a set of one or more integrated memory controller unit(s) circuitry 814 in the system agent unit circuitry 810, and special purpose logic 808, as well as a set of one or more interface controller unit(s) circuitry 816. Note that the processor and/or SoC 800 may be one of the processors 770 or 780, or co-processor 738 or 715 of FIG. 7.

Thus, different implementations of the processor and/or SoC 800 may include: 1) a CPU with the special purpose logic 808 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like(which may include one or more cores, not shown), and the cores 802(A)-(N) being one or more general purpose cores (e.g., general purpose in-order cores, general purpose out-of-order cores, or a combination of the two); 2) a co-processor with the cores 802(A)-(N) being a large number of special purpose cores intended primarily for graphics and/or scientific (throughput); and 3) a co-processor with the cores 802(A)-(N) being a large number of general purpose in-order cores. Thus, the processor and/or SoC 800 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804(A)-(N) within the cores 802(A)-(N), a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples interface network circuitry 812 (e.g., a ring interconnect) interfaces the special purpose logic 808 (e.g., integrated graphics logic), the set of shared cache unit(s) circuitry 806, and the system agent unit circuitry 810, alternative examples use any number of well-known techniques for interfacing such units. In some examples, coherency is maintained between one or more of the shared cache unit(s) circuitry 806 and cores 802(A)-(N). In some examples, interface controller unit(s) circuitry 816 couple the cores 802(A)-(N) to one or more other devices 818 such as one or more I/O devices, storage, one or more communication devices (e.g., wireless networking, wired networking, etc.), etc.

In some examples, one or more of the cores 802(A)-(N) are capable of multi-threading. The system agent unit circuitry 810 includes those components coordinating and operating cores 802(A)-(N). The system agent unit circuitry 810 may include, for example, power control unit (PCU) circuitry and/or display unit circuitry (not shown). The PCU may be or may include logic and components needed for regulating the power state of the cores 802(A)-(N) and/or the special purpose logic 808 (e.g., integrated graphics logic). The display unit circuitry is for driving one or more externally connected displays.

The cores 802(A)-(N) may be homogenous in terms of instruction set architecture (ISA). Alternatively, the cores 802(A)-(N) may be heterogeneous in terms of ISA; that is, a subset of the cores 802(A)-(N) may be capable of executing an ISA, while other cores may be capable of executing only a subset of that ISA or another ISA.

### Example Core Architectures—In-Order and Out-of-Order Core Block Diagram

FIG. 9(A) is a block diagram illustrating both an example in-order pipeline and an example register renaming, out-of-order issue/execution pipeline according to examples. FIG. 9(B) is a block diagram illustrating both an example in-order architecture core and an example register renaming, out-of-order issue/execution architecture core to be included in a processor according to examples. The solid lined boxes in FIG. 9(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9(A), a processor pipeline 900 includes a fetch stage 902, an optional length decoding stage 904, a decode stage 906, an optional allocation (Alloc) stage 908, an optional renaming stage 910, a schedule (also known as a dispatch or issue) stage 912, an optional register read/memory read stage 914, an execute stage 916, a write back/memory write stage 918, an optional exception handling stage 922, and an optional commit stage 924. One or more operations can be performed in each of these processor pipeline stages. For example, during the fetch stage 902, one or more instructions are fetched from instruction memory, and during the decode stage 906, the one or more fetched instructions may be decoded, addresses (e.g., load store unit (LSU) addresses) using forwarded register ports may be generated, and branch forwarding (e.g., immediate offset or a link register (LR)) may be performed. In some examples, the decode stage 906 and the register read/memory read stage 914 may be combined into one pipeline stage. In some examples, during the execute stage 916, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 9(B) may implement the pipeline 900 as follows: 1) the instruction fetch circuitry 938 performs the fetch and length decoding stages 902 and 904; 2) the decode circuitry 940 performs the decode stage 906; 3) the rename/allocator unit circuitry 952 performs the allocation stage 908 and renaming stage 910; 4) the scheduler(s) circuitry 956 performs the schedule stage 912; 5) the physical register file(s) circuitry 958 and the memory unit circuitry 970 perform the register read/memory read stage 914; the execution cluster(s) 960 perform the execute stage 916; 6) the memory unit circuitry 970 and the physical register file(s) circuitry 958 perform the write back/memory write stage 918; 7) various circuitry may be involved in the exception handling stage 922; and 8) the retirement unit circuitry 954 and the physical register file(s) circuitry 958 perform the commit stage 924.

FIG. 9(B) shows a processor core 990 including front-end unit circuitry 930 coupled to execution engine unit circuitry 950, and both are coupled to memory unit circuitry 970. The core 990 may be a reduced instruction set architecture computing (RISC) core, a complex instruction set architecture computing (CISC) core, a very long instruction word (VLIW) core, or a hybrid or alternative core type. As yet another option, the core 990 may be a special-purpose core, such as, for example, a network or communication core, compression engine, co-processor core, general purpose computing graphics processing unit (GPGPU) core, graphics core, or the like.

The front-end unit circuitry 930 may include branch prediction circuitry 932 coupled to instruction cache circuitry 934, which is coupled to an instruction translation lookaside buffer (TLB) 936, which is coupled to instruction fetch circuitry 938, which is coupled to decode circuitry 940. In some examples, the instruction cache circuitry 934 is included in the memory unit circuitry 970 rather than the front-end unit circuitry 930. The decode circuitry 940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 940 may further include address generation unit (AGU, not shown) circuitry. In some examples, the AGU generates an LSU address using forwarded register ports, and may further perform branch forwarding (e.g., immediate offset branch forwarding, LR register branch forwarding, etc.). The decode circuitry 940 may be implemented using various different mechanisms. Examples of suitable mechanisms include, but are not limited to, look-up tables, hardware implementations, programmable logic arrays (PLAs), microcode read only memories (ROMs), etc. In some examples, the core 990 includes a microcode ROM (not shown) or other medium that stores microcode for certain macroinstructions (e.g., in decode circuitry 940 or otherwise within the front-end unit circuitry 930). In some examples, the decode circuitry 940 includes a micro-operation (micro-op) or operation cache (not shown) to hold/cache decoded operations, micro-tags, or micro-operations generated during the decode or other stages of the processor pipeline 900. The decode circuitry 940 may be coupled to rename/allocator unit circuitry 952 in the execution engine unit circuitry 950.

The execution engine unit circuitry 950 includes the rename/allocator unit circuitry 952 coupled to retirement unit circuitry 954 and a set of one or more scheduler(s) circuitry 956. The scheduler(s) circuitry 956 represents any number of different schedulers, including reservations stations, central instruction window, etc. In some examples, the scheduler(s) circuitry 956 can include arithmetic logic unit (ALU) scheduler/scheduling circuitry, ALU queues, address generation unit (AGU) scheduler/scheduling circuitry, AGU queues, etc. The scheduler(s) circuitry 956 is coupled to the physical register file(s) circuitry 958. Each of the physical register file(s) circuitry 958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In some examples, the physical register file(s) circuitry 958 includes vector registers unit circuitry, writemask registers unit circuitry, and scalar register unit circuitry. These register units may provide architectural vector registers, vector mask registers, general-purpose registers, etc. The physical register file(s) circuitry 958 is coupled to the retirement unit circuitry 954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 954 and the physical register file(s) circuitry 958 are coupled to the execution cluster(s) 960. The execution cluster(s) 960 includes a set of one or more execution unit(s) circuitry 962 and a set of one or more memory access circuitry 964. The execution unit(s) circuitry 962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). In some examples, execution unit(s) circuitry 962 may include hardware to support functionality for instructions for one or more of a compression engine, graphics processing, neural-network processing, in-memory analytics, matrix operations, cryptographic operations, data streaming operations, data graph operations, etc.

While some examples may include a number of execution units or execution unit circuitry dedicated to specific functions or sets of functions, other examples may include only one execution unit circuitry or multiple execution units/execution unit circuitry that all perform all functions. The scheduler(s) circuitry 956, physical register file(s) circuitry 958, and execution cluster(s) 960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster - and in the case of a separate memory access pipeline, certain examples are implemented in which only the execution cluster of this pipeline has the memory access unit(s) circuitry 964). It should also be understood that where separate pipelines are used, one or more of these pipelines may be out-of-order issue/execution and the rest in-order.

In some examples, the execution engine unit circuitry 950 may perform load store unit (LSU) address/data pipelining to an Advanced Microcontroller Bus (AMB) interface (not shown), and address phase and writeback, data phase load, store, and branches.

The set of memory access circuitry 964 is coupled to the memory unit circuitry 970, which includes data TLB circuitry 972 coupled to data cache circuitry 974 coupled to level 2 (L2) cache circuitry 976. In some examples, the memory access circuitry 964 may include load unit circuitry, store address unit circuitry, and store data unit circuitry, each of which is coupled to the data TLB circuitry 972 in the memory unit circuitry 970. The instruction cache circuitry 934 is further coupled to the level 2 (L2) cache circuitry 976 in the memory unit circuitry 970. In some examples, the instruction cache 934 and the data cache 974 are combined into a single instruction and data cache (not shown) in L2 cache circuitry 976, level 3 (L3) cache circuitry (not shown), and/or main memory. The L2 cache circuitry 976 is coupled to one or more other levels of cache and eventually to a main memory.

The core 990 may support one or more instructions sets (e.g., the x86 instruction set architecture (optionally with some extensions that have been added with newer versions); the MIPS instruction set architecture; the ARM instruction set architecture (optionally with optional additional extensions such as NEON, etc.); RISC instruction set architecture), including the instruction(s) described herein. In some examples, the core 990 includes logic to support a packed data instruction set architecture extension (e.g., AVX1, AVX2, AVX512, AMX, etc.), thereby allowing the operations used by many multimedia applications to be performed using packed data.

### Example Execution Unit(s) Circuitry

FIG. 10 illustrates examples of execution unit(s) circuitry, such as execution unit(s) circuitry 962 of FIG. 9(B). As illustrated, execution unit(s) circuitry 962 may include one or more ALU circuits 1001, optional vector/single instruction multiple data (SIMD) circuits 1003, load/store circuits 1005, branch/jump circuits 1007, and/or Floating-point unit (FPU) circuits 1009. ALU circuits 1001 perform integer arithmetic and/or Boolean operations. Vector/SIMD circuits 1003 perform vector/SIMD operations on packed data (such as SIMD/vector registers). Load/store circuits 1005 execute load and store instructions to load data from memory into registers or store from registers to memory. Load/store circuits 1005 may also generate addresses. Branch/jump circuits 1007 cause a branch or jump to a memory address depending on the instruction. FPU circuits 1009 perform floating-point arithmetic. The width of the execution unit(s) circuitry 962 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture

FIG. 11 is a block diagram of a register architecture 1100 according to some examples. As illustrated, the register architecture 1100 includes vector/SIMD registers 1110 that vary from 128-bit to 1,024 bits width. In some examples, the vector/SIMD registers 1110 are physically 512-bits and, depending upon the mapping, only some of the lower bits are used. For example, in some examples, the vector/SIMD registers 1110 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1100 includes writemask/predicate registers 1115. For example, in some examples, there are 8 writemask/predicate registers (sometimes called k0 through k7) that are each 16-bit, 32-bit, 64-bit, or 128-bit in size. Writemask/predicate registers 1115 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1115 corresponds to a data element position of the destination. In other examples, the writemask/predicate registers 1115 are scalable and consists of a set number of enable bits for a given vector element (e.g., 8 enable bits per 64-bit vector element).

The register architecture 1100 includes a plurality of general-purpose registers 1125. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1100 includes scalar floating-point (FP) register file 1145 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1140 (e.g., EFLAGS, RFLAGS, etc.) store status and control information for arithmetic, compare, and system operations. For example, the one or more flag registers 1140 may store condition code information such as carry, parity, auxiliary carry, zero, sign, and overflow. In some examples, the one or more flag registers 1140 are called program status and control registers.

Segment registers 1120 contain segment points for use in accessing memory. In some examples, these registers are referenced by the names CS, DS, SS, ES, FS, and GS.

Model specific registers or machine specific registers (MSRs) 1135 control and report on processor performance. Most MSRs 1135 handle system-related functions and are not accessible to an application program. For example, MSRs may provide control for one or more of: performance-monitoring counters, debug extensions, memory type range registers, thermal and power management, instruction-specific support, and/or processor feature/mode support. Machine check registers 1160 consist of control, status, and error reporting MSRs that are used to detect and report on hardware errors. Control register(s) 1155 (e.g., CR0-CR4) determine the operating mode of a processor (e.g., processor 770, 780, 738, 715, and/or 800) and the characteristics of a currently executing task. In some examples, MSRs 1135 are a subset of control registers 1155.

One or more instruction pointer register(s) 1130 store an instruction pointer value. Debug registers 1150 control and allow for the monitoring of a processor or core's debugging operations.

Memory (mem) management registers 1165 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1100 may, for example, be used in register file/memory 508, or physical register file(s) circuitry 9 58.

### Instruction Set Architectures

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 12 illustrates examples of an instruction format. As illustrated, an instruction may include multiple components including, but not limited to, one or more fields for: one or more prefixes, an opcode, addressing information (e.g., register identifiers, memory addressing information, etc.), a displacement value, and/or an immediate value. Note that some instructions utilize some or all the fields of the format whereas others may only use the field for the opcode 1203. In some examples, the order illustrated is the order in which these fields are to be encoded, however, it should be appreciated that in other examples these fields may be encoded in a different order, combined, etc.

The prefix(es) f 1201, when used, modifies an instruction. In some examples, one or more prefixes are used to repeat string instructions (e.g., 0×F0, 0×F2, 0×F3, etc.), to provide section overrides (e.g., 0×2E, 0×36, 0×3E, 0×26, 0×64, 0×65, 0×2E, 0×3E, etc.), to perform bus lock operations, and/or to change operand (e.g., 0×66) and address sizes (e.g., 0×67). Certain instructions require a mandatory prefix (e.g., 0×66, 0×F2, 0×F3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1203 is used to at least partially define the operation to be performed upon a decoding of the instruction. In some examples, a primary opcode encoded in the opcode field 1203 is one, two, or three bytes in length. In other examples, a primary opcode can be a different length. An additional 3-bit opcode field is sometimes encoded in another field.

The addressing information field 1205 is used to address one or more operands of the instruction, such as a location in memory or one or more registers. FIG. 13 illustrates examples of the addressing information field 1205. In this illustration, an optional MOD R/M byte 1302 and an optional Scale, Index, Base (SIB) byte 1304 are shown. The MOD R/M byte 1302 and the SIB byte 1304 are used to encode up to two operands of an instruction, each of which is a direct register or effective memory address. Note that both of these fields are optional in that not all instructions include one or more of these fields. The MOD R/M byte 1302 includes a MOD field 1342, a register (reg) field 1344, and R/M field 1346.

The content of the MOD field 1342 distinguishes between memory access and non-memory access modes. In some examples, when the MOD field 1342 has a binary value of 11 (11b), a register-direct addressing mode is utilized, and otherwise a register-indirect addressing mode is used.

The register field 1344 may encode either the destination register operand or a source register operand or may encode an opcode extension and not be used to encode any instruction operand. The content of register field 1344, directly or through address generation, specifies the locations of a source or destination operand (either in a register or in memory). In some examples, the register field 1344 is supplemented with an additional bit from a prefix (e.g., prefix 1201) to allow for greater addressing.

The R/M field 1346 may be used to encode an instruction operand that references a memory address or may be used to encode either the destination register operand or a source register operand. Note the R/M field 1346 may be combined with the MOD field 1342 to dictate an addressing mode in some examples.

The SIB byte 1304 includes a scale field 1352, an index field 1354, and a base field 1356 to be used in the generation of an address. The scale field 1352 indicates a scaling factor. The index field 1354 specifies an index register to use. In some examples, the index field 1354 is supplemented with an additional bit from a prefix (e.g., prefix 1201) to allow for greater addressing. The base field 1356 specifies a base register to use. In some examples, the base field 1356 is supplemented with an additional bit from a prefix (e.g., prefix 1201) to allow for greater addressing. In practice, the content of the scale field 1352 allows for the scaling of the content of the index field 1354 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1207 provides this value. Additionally, in some examples, a displacement factor usage is encoded in the MOD field of the addressing information field 1205 that indicates a compressed displacement scheme for which a displacement value is calculated and stored in the displacement field 1207.

In some examples, the immediate value field 1209 specifies an immediate value for the instruction. An immediate value may be encoded as a 1-byte value, a 2-byte value, a 4-byte value, etc.

References to “some examples,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Furthermore, the disclosure describes examples in detail as noted above. Further examples are noted below:
Example 1. A processor comprising:
an integer logic circuit to dispatch an integer store data operation to route integer data to a destination on a first set of connection lines; and
a vector logic circuit to schedule a vector store data operation to transfer vector data to the destination, block dispatch of an integer store data operation to the destination, route higher bits of the vector data via a second set of connection lines to a destination, and route lower bits of the vector data to the integer logic circuit and use the first set of connection lines used for routing of integer data to the destination to route the lower bits of the vector data to the destination.
Example 2. The processor according to Example 1, wherein the integer data has a length of n-bits and the vector data has a length of m-bits, where m>n, and in which the vector data comprises n number of lower bits and m−n number of higher bits.
Example 3. The processor according to Example 1, wherein the integer data has a length of 64 bits and the vector data has a length of 128 bits.
Example 4. The processor according to any one of Examples 1-3 further comprising a schedular to schedule the vector store data operation and block dispatch of the integer store data operation to the destination.
Example 5. The processor according to any one of Examples 1-4, wherein the destination combines the higher bits of the vector data and the lower bits of the vector data, prior to releasing the vector data.
Example 6. The processor according to any one of Examples 1-5, wherein to block dispatch of the integer store data operation to the destination comprises:
always block dispatch of the integer store data operation to the destination;
limit dispatch of the vector store data operation to the destination to no more than N times in an M time period or M time cycle; or
before dispatch of the vector data, determine if any integer data dispatch was previously blocked and:
   if no, dispatch the vector store data operation; and
   if yes, allow the integer data previously blocked to be routed before dispatch of the vector store data operation.
Example 7. A method to share data lines between vector and integer operations comprising:
scheduling a dispatch of a vector store data operation to transfer vector data to a destination;
blocking dispatch of an integer store data operation to the destination;
routing lower bits of the vector data to a first set of connection lines used for routing of integer data to the destination and using the first set of connection lines to route the lower bits of the vector data to the destination; and
routing higher bits of the vector data via a second set of connection lines to a destination.
Example 8. The method according to Example 7 further comprising combining the higher bits of the vector data and the lower bits of the vector data at the destination.
Example 9. The method according to any one of Examples 7-8, further comprising dispatching integer data on the first set of connection lines for routing to the destination when no vector data operation is scheduled.
Example 10. The method according to any one of claims 7-9, wherein blocking dispatch of the integer store data operation to the destination comprises always blocking dispatch of the integer store data operation to the destination, when scheduling the dispatch of the vector store data operation.
Example 11. The method according to any one of Examples 7-10, wherein blocking dispatch of the integer store data operation to the destination comprises limiting dispatch of the vector store data operation to the destination to no more than N times in an M time period or M time cycle.
Example 12. The method according to any one of Examples 7-11, wherein blocking dispatch of the integer store data operation to the destination comprises, before dispatch of the vector data, determining if any integer data dispatch was previously blocked and:
if no, dispatch the vector store data operation; and
if yes, allow the integer data previously blocked to be routed before dispatching the vector store data operation.
Example 13. A system comprising:
a memory;
a switch coupled to the memory;
a cluster of integer units, each integer unit having an integer logic circuit to dispatch an integer store data operation to route integer data to the switch on a first set of connection lines, wherein the switch switches corresponding one of the first set of connection lines onto a third set of connection lines to the memory; and
a cluster of vector units, each vector unit having a vector logic circuit to schedule a vector store data operation to transfer vector data to the memory, block dispatch of an integer store data operation to the memory, route higher bits of the vector data via a second set of connection lines to the memory, and route lower bits of the vector data to a corresponding integer logic circuit and use the first set of connection lines used for routing of integer data to the switch, wherein the switch to route the lower bits of the vector data to the memory on the third set of connection lines.
Example 14. The system according to Example 13 further comprising a schedular for each vector logic circuit to schedule the vector store data operation and block dispatch of the integer store data operation to the memory.
Example 15. The system according to any one of Examples 13-14, wherein the memory combines the higher bits of the vector data and the lower bits of the vector data, prior to releasing the vector data from the memory.
Example 16. The system according to any one of Examples 13-15, wherein the memory is a cache memory.
Example 17. The system according to any one of Examples 13-16, wherein the integer data has a length of n-bits and the vector data has a length of m-bits, where m>n, and in which the vector data comprises n number of lower bits and m−n number of higher bits.
Example 18. The system according to any one of Examples 13-17, wherein the third set of connection lines is n-bits for the cluster of integer units.
Example 19. The system according to any one of Examples 13-18, wherein the integer data has a length of 64 bits and the vector data has a length of 128 bits.
Example 20. The system according to any one of Examples 13-19, further comprising cross-cluster transfer of vector data between the clusters, wherein the cross-cluster transfer of vector data between the clusters does not require a block of dispatch of an integer store data operation to the memory.

What is claimed is:

1. A processor comprising:
an integer logic circuit to dispatch an integer store data operation to route integer data to a destination on a first set of connection lines; and
a vector logic circuit to schedule a vector store data operation to transfer vector data to the destination, block dispatch of an integer store data operation to the destination, route higher bits of the vector data via a second set of connection lines to a destination, and route lower bits of the vector data to the integer logic circuit and use the first set of connection lines used for routing of integer data to the destination to route the lower bits of the vector data to the destination.

2. The processor according to claim 1, wherein the integer data has a length of n-bits and the vector data has a length of m-bits, where m>n, and in which the vector data comprises n number of lower bits and m−n number of higher bits.

3. The processor according to claim 1, wherein the integer data has a length of 64 bits and the vector data has a length of 128 bits.

4. The processor according to claim 1 further comprising a schedular to schedule the vector store data operation and block dispatch of the integer store data operation to the destination.

5. The processor according to claim 1, wherein the destination combines the higher bits of the vector data and the lower bits of the vector data, prior to releasing the vector data.

6. The processor according to claim 1, wherein to block dispatch of the integer store data operation to the destination comprises:
always block dispatch of the integer store data operation to the destination;
limit dispatch of the vector store data operation to the destination to no more than N times in an M time period or M time cycle; or
before dispatch of the vector data, determine if any integer data dispatch was previously blocked and:
if no, dispatch the vector store data operation; and
if yes, allow the integer data previously blocked to be routed before dispatch of the vector store data operation.

7. A method to share data lines between vector and integer operations comprising:
scheduling a dispatch of a vector store data operation to transfer vector data to a destination;
blocking dispatch of an integer store data operation to the destination;
routing lower bits of the vector data to a first set of connection lines used for routing of integer data to the destination and using the first set of connection lines to route the lower bits of the vector data to the destination; and
routing higher bits of the vector data via a second set of connection lines to a destination.

8. The method according to claim 7 further comprising combining the higher bits of the vector data and the lower bits of the vector data at the destination.

9. The method according to claim 7, further comprising dispatching integer data on the first set of connection lines for routing to the destination when no vector data operation is scheduled.

10. The method according to claim 7, wherein blocking dispatch of the integer store data operation to the destination comprises always blocking dispatch of the integer store data operation to the destination, when scheduling the dispatch of the vector store data operation.

11. The method according to claim 7, wherein blocking dispatch of the integer store data operation to the destination comprises limiting dispatch of the vector store data operation to the destination to no more than N times in an M time period or M time cycle.

12. The method according to claim 7, wherein blocking dispatch of the integer store data operation to the destination comprises, before dispatch of the vector data, determining if any integer data dispatch was previously blocked and:
if no, dispatch the vector store data operation; and
if yes, allow the integer data previously blocked to be routed before dispatching the vector store data operation.

13. A system comprising:
a memory;
a switch coupled to the memory;
a cluster of integer units, each integer unit having an integer logic circuit to dispatch an integer store data operation to route integer data to the switch on a first set of connection lines, wherein the switch switches corresponding one of the first set of connection lines onto a third set of connection lines to the memory; and
a cluster of vector units, each vector unit having a vector logic circuit to schedule a vector store data operation to transfer vector data to the memory, block dispatch of an integer store data operation to the memory, route higher bits of the vector data via a second set of connection lines to the memory, and route lower bits of the vector data to a corresponding integer logic circuit and use the first set of connection lines used for routing of integer data to the switch, wherein the switch to route the lower bits of the vector data to the memory on the third set of connection lines.

14. The system according to claim 13 further comprising a schedular for each vector logic circuit to schedule the vector store data operation and block dispatch of the integer store data operation to the memory.

15. The system according to claim 13, wherein the memory combines the higher bits of the vector data and the lower bits of the vector data, prior to releasing the vector data from the memory.

16. The system according to claim 15, wherein the memory is a cache memory.

17. The system according to claim 13, wherein the integer data has a length of n-bits and the vector data has a length of m-bits, where m>n, and in which the vector data comprises n number of lower bits and m−n number of higher bits.

18. The system according to claim 17, wherein the third set of connection lines is n-bits for the cluster of integer units.

19. The system according to claim 13, wherein the integer data has a length of 64 bits and the vector data has a length of 128 bits.

20. The system according to claim 13, further comprising cross-cluster transfer of vector data between the clusters, wherein the cross-cluster transfer of vector data between the clusters does not require a block of dispatch of an integer store data operation to the memory.
